(19) United States
(12) Patent Application Publication
(10) Pub. No.: US 2012/0145340 A1
(43) Pub. Date: Jun. 14, 2012

(54) SYSTEM AND METHOD FOR FORMING CREASED OR UNCREASED RUFFLES ON A WEB

(75) Inventors: Lynda B. Middlemas, Amelia Island, FL (US); Amanda M. Middlemas, Washington, DC (US)

(73) Assignee: EVERYDAY HAUTE, LLC, FERNANDINA BEACH, FL (US)

(21) Appl. No.: 12/964,445

(22) Filed: Dec. 9, 2010

(51) Int. Cl. B31F 1/12

(52) U.S. Cl. 162/111

(57) ABSTRACT

Systems and methods for forming creased or uncreased ruffles along one or more outside edges of a sheet entail integral formation or attachment of a ruffle strip. Integral formation entails selectively compacting unruffled areas of a web, stretching (e.g., embossing) ruffled areas, or compacting an entire web and subsequently stretching ruffled areas. Attachment methods entail forming a ruffle strip and gluing or stitching it to a web.

### FIELD OF THE INVENTION

This invention relates generally to paper processing, and, more particularly to systems and methods for forming creased or uncreased ruffles on a web.

### BACKGROUND

In the past, many attempts have been made to enhance physical and aesthetic properties of textiles, nonwovens and paper products, e.g., napkins and hand towels. By way of example, paper napkins are typically made from one up to four plies and in a variety of qualities, sizes, folds, colors and patterns depending on intended use and prevailing fashions. The composition of raw materials varies considerably, depending upon requirements and quality.

One technique for imparting unique physical and aesthetic properties to paper products is creping. Crepe paper is typically produced on a paper machine with a single large steam heated drying cylinder (yankee) fitted with a hot air hood. The yankee cylinder is sprayed with adhesives to make the paper stick. Creping is accomplished by the yankee's doctor blade that is scraping the dry paper of the cylinder surface. The crinkle (creping) is controlled by the strength of the adhesive, geometry of the doctor blade, speed difference between the yankee and final section of the paper machine and paper pulp characteristics.

Another technique for imparting unique physical and aesthetic properties to paper products is calendering. Calendering modifies the surface characteristics of paper with regard to its further use. Calendering can impart a specific gloss, smoothness/roughness, density, brightness and opacity.

Yet another technique for imparting unique physical and aesthetic properties is coating. Coating affects the surface properties of the paper. The effect of coating may be aimed at optical properties such as brightness, gloss or opacity, at tactile properties such as smoothness, but, most importantly, at printability and print image quality.

While available paper processing techniques are useful for producing a wide array of unique features, they do not satisfactorily enable mass production of paper products having creased or uncreased ruffles formed along one or more sections (e.g., free edges). Ruffles can provide not only a unique aesthetic appearance but also unique physical properties at the ruffled edge. A system and method are needed for forming creased or uncreased ruffles along one or more outside edges of a sheet, efficiently and cost effectively, during small scale and mass production of paper and paper-like products.

Furthermore, there exists an intense desire in the paper industry to create disposable products from papermaking fibers which can substitute for conventional cloth products used for the purpose of wiping and cleaning. Their physical properties, appearance and functioning must closely duplicate the cloth based products in order to gain market acceptance. For example, their softness, bulk, extensibility, absorbency, presentation and dispensability, should match their cloth counterparts.

Softness is expected from all wiping products. Not only does it feel better to handle a soft wiping product, but it also gives a sense of greater wiping ability and absorbency. Absorbency is the ability to soak up liquids quickly. Another indication of softness and absorbency is bulk, the thickness of the sheet, which makes it “bulky” and cloth-like. It is a frequent practice to use more than one ply to make the product bulky, which has cost implications. Extensibility allows the product conform to the shape of the hand. This further increases the comfort in use.

From the aesthetic point of view, cloth napkins and towels are usually bordered. This border could be in the form of hemming, tufting, or ruffling. The closest simulation of this in a paper napkin is the embossed border pattern on typical dinner napkins. A method of embossing in the middle and crushing the sheet for the borders is described in U.S. Pat. No. 1,771,983. The crushing pressure in the above methods makes the edges harsh to the feel, makes them thin and “papery” and reduces absorbency along the edges. In order to overcome the thin and harsh edges, U.S. Pat. No. 1,774,497 folds the edges over and seals them, a fairly complex and wasteful process. U.S. Pat. No. 2,020,668 describes the process of manufacturing a two or more plied handkerchief with hemmed edges. The sheets are unattached to each other except along a band which lies substantially inside the margin of the handkerchief. The unattached portion outside the bands is free to separate and independently ruffle. All of the above patents describe the use of more than one ply to make the product.

Disposable towels on the other hand are usually embossed over their entire surface for increasing bulk, extensibility and absorbency. The full coverage with the pattern usually gives them a grainy and unattractive appearance.

Conventional creped tissue paper is formed from aqueous slurries, and the principle source of strength is from inter-fiber bonds formed by the hydrate bonding process associated with papermaking. Stiffness of paper is associated with the concentration of bonds, bonds per unit area of the sheet. Adding small amounts of de-bonder to the slurry will make a softer but weaker sheet. Adding more fiber to make a bulkier sheet will form an undesirably stiffer sheet. Experience dictates that two thinner sheets put together make a considerably softer sheet than a thicker sheet made in the conventional process using the same slurry. It is, therefore, a common practice to make disposable napkins and towels using more than one ply. The disadvantage of this process is that it requires running the paper machine several times to make the same length of the final product.

Various methods have been employed to make bulkier and softer sheets. U.S. Pat. No. 3,879,257 describes a recrepe process in which the creped web from the first dryer is printed in a mesh pattern with an elastomeric material on one side, and then adhered to a second drying cylinder and creped off, the bonding agent acting as the adhering agent. It is printed again on the other side of the web and recreped on a third drying cylinder. The strength of the elastomeric material and the breakdown of the bonds in the unprinted areas as a result of repeated creping create a fairly bulky, strong and absorbent sheet.

Another process to add bulk and extensibility to the web is described in U.S. Pat. No. 6,416,623. Partially dried creped web from the drying cylinder is embossed in a press nip of a heated cylinder and soft rubber belt or wire pressing against it. Either the cylinder or the belt or the wire is patterned. The web is finally dried. The process produces bulky sheet with high extensibility.

The papermaking processes do not allow for making a non-uniform web comprising discrete machine direction bands with different properties, such as, uncreped bands or bands of dissimilar crepe, or embossed bands interspersed with bands of dissimilar embossing or absence of embossing.

U.S. Pat. No. 1,506,592 discusses a process to make ordinary crepe paper or other crepe material with ruffles to enhance the decorative effect. It is an off paper machine process where the web is folded longitudinally, each fold in the form of a pleat. It is then adhered to a heated cylinder with adhesive, dried and creped. The web is creped everywhere except the outside layers of the fold which ruffle up. The process though practical for the much stronger decorative paper would have operational problems for much weaker sanitary paper, such as sheet breakage at the crepe blade, non-uniform crepe under the folds, and mutual bonding of the folds due to adhesive penetration through the layers of the fold.

The invention is directed to overcoming one or more of the problems and solving one or more of the needs as set forth above.

### SUMMARY OF THE INVENTION

To solve one or more of the problems set forth above, in an exemplary implementation of the invention, systems and methods for forming creased or uncreased ruffles along one or more outside edges of a sheet are provided. The systems and methods entail integral formation or attachment of a ruffle strip. Ruffles may be integrally formed on a web by selectively compacting unruffled areas of a web, or by stretching (e.g., embossing) ruffled areas, or by compacting an entire web and subsequently stretching ruffled areas. Alternatively, ruffles may be formed as a separate strip that converges with a web in a manufacturing line and is glued or stitched to the web.

The invention enables production of single ply fibrous products that exhibit enhanced softness, bulk and absorbency. However, the invention is not limited to producing such products.

The process of compacting the web is mechanical. Compressive force is applied to the traveling length of the web to retard it and cause it to buckle. The web buckles to create a wave-like structure without undue degradation of the strength of the web. The frequency of the wave depends on the stiffness characteristic of the substrate and the friction coefficient of the driving and retarding surfaces. The bulkiness of the compacted web increases with this frequency. Other qualities such as extensibility, absorption, flexibility, draping ability and softness increase with no or minimal strength degradation of the base web. In some cases, the resulting product exhibits enhanced tensile strength. Suitable equipment for achieving this compaction may be obtained from Micrex Corporation of Walpole, Mass.

The systems and methods of the present invention enable production of products having creased or uncreased ruffles formed along one or more sections (e.g., free edges). The ruffles provide not only a unique aesthetic appearance but also unique physical properties (e.g., loosely compacted paper) at the ruffled edge.

A sheet is created when a web is slit. A method of forming a ruffle along an edge of a sheet of a substrate material in accordance with principles of the invention includes a step of forming a ruffle zone between lateral edges of a web of nonwoven material traveling in a machine direction. The ruffle zone includes a loosely compacted region between adjacent parallel tightly compacted regions on the web. The ruffle zone is cut in the machine direction (i.e., the direction of travel of the web) between the parallel tightly compacted regions on the web. The cutting divides the ruffle zone and forms opposed edges. At least one of the opposed edges is ruffled.

The step of cutting the ruffle zone in the machine direction between the parallel tightly compacted regions on the web includes tangential shear slitting between two edge-contacting circular slitter blade, including a top slitter blade and a bottom slitter blade vertically supported in a path of machine direction travel in alignment with the ruffle zone, e.g., in alignment with a midline of the ruffle zone or offset from the midline. Another implementation includes crush cutting. In this cutting technique, the material is severed when it is nipped between a sharp-edged cutter element and an anvil element.

In one embodiment, the parallel tightly compacted regions may be formed on the web by selectively creping or microcreping areas of the web to constitute the parallel tightly compacted regions. The area between the parallel tightly compacted regions comprises the loosely compacted region is not microcreped and exhibits diminishing transitional compaction from tight compaction of the adjacent parallel tightly compacted regions.

In a particular embodiment, the parallel tightly compacted regions are formed on the web by selectively microcreping areas of the web using the Micrex® process. The Micrex® process is performed using a retarder with a cutout corresponding to the loosely compacted region. The cutout avoids retarder contact with the loosely compacted region during the Micrex® process.

Optionally, the parallel tightly compacted regions and/or the entire web may be heat set to provide enhanced stability and durability. Also optionally, the cut ruffle zone may be mechanically or pneumatically fluffed to mechanically enhance the amplitude of undulations comprising ruffles.

In another embodiment, a plurality of ruffle zones are formed between lateral edges of a web of nonwoven material traveling in a machine direction. Each ruffle zone comprises a loosely compacted region between adjacent parallel tightly compacted regions on the web. Each ruffle zone may be cut (e.g., slit) in the machine direction between the corresponding adjacent parallel tightly compacted regions on the web. The cutting divides the ruffle zone and forms opposed edges of separate sheets of the nonwoven material. Each of the opposed edges is ruffled. This embodiment produces a plurality of sheets with ruffled edges from a single web. The optional steps and particular compaction steps described above may be applied in this embodiment.

An exemplary product of a process as described above is a unitary ruffled sheet. The unitary ruffled sheet is a thin sheet of material with a plurality of edges. At least one edge is an integrally formed ruffled edge. In a particular preferred embodiment each lateral edge is an integrally formed ruffled edge. Each ruffled edge comprises loosely compacted sheet material that is not microcreped. At least a portion of the thin sheet that abuts each ruffled edge (but excludes the ruffled edge) comprises tightly compacted sheet material. The tightly compacted sheet material is microcreped sheet material compacted in a direction parallel to the ruffled edge. The tightly compacted sheet material is compacted from about 10% to 40%, preferably about 15%-30%.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a top perspective view of exemplary embossing cylinders according to principles of the invention; and

FIG. 2 is a front view of an exemplary embossing cylinders according to principles of the invention; and

FIG. 3 is a front view of an exemplary microcreping blade and cylinder according to principles of the invention; and

FIG. 4 is a top perspective view of an exemplary microcreping blade and cylinder according to principles of the invention; and

FIG. 5 is a side view of an exemplary slitting arrangement according to principles of the invention; and

FIG. 6 is a front view of an exemplary slitting arrangement according to principles of the invention; and

FIG. 7 is a perspective view of an exemplary slitting arrangement according to principles of the invention; and

FIG. 8 is an exemplary flowchart illustrating steps of a ruffling process according to principles of the invention; and

FIG. 9 is a top perspective view of an exemplary separate ruffle strip, elastic strip and paper web according to principles of the invention; and

FIG. 10 is a top plan view of a paper hand towel having a ruffled edge according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures.

### DETAILED DESCRIPTION

The system and method of the present invention enables mass production of paper products having creased or uncreased ruffles formed along one or more sections (e.g., free edges). The ruffles provide not only a unique aesthetic appearance but also unique physical properties at the ruffled edge.

Ruffles according to principles of the invention may be creased or uncreased. As used herein, an uncreased ruffle is an area of smooth undulation, without creases, that defines an edge of a sheet. The ruffle may be tightly gathered where it abuts the sheet and increasingly wavelike towards the free end thereof. A pleat is a creased ruffle. The configuration (e.g., width) of the ruffle is not a limiting factor.

A ruffle according to principles of the invention may be formed on any substrate that is processed as a web or sheet and exhibits adequate structural properties. Paper and paper-like materials are examples of suitable substrates. Thus, a ruffle may be formed on a broad range of paper products, including, but not limited to, folded hand towels, folded napkins, rolled bath tissue and streamers, each of which is typically formed from a continuous web supplied from a paper roll. Additionally, ruffles formed in accordance with the principles of the invention may be attached to other substrates, including, but not limited to gift bags.

The web may be comprised of any substrate capable of supporting a ruffle. Various non-woven materials and textiles may be used, including, but not limited to fabrics. In an embodiment having a ruffle formed by embossing, creping or microcreping, a substrate that exhibits substantially inelastic stretch is preferred. By way of example and not limitation, air laid nonwoven web, spun lace nonwoven webs, or DRC (Double Re-Crepe) cellulose webs are examples of nonwovens that may be used. As between the three, air laid and spun lace are particularly preferred for aesthetic reasons.

Air laid nonwoven refers to a manufacturing technology that produces a web from short fibers, most often softwood pulp. The process is also referred to as short fiber air laid technology. Unlike conventional paper making where wood pulp is bonded principally by a chemical reaction between the pulp's natural cellulose and water, air laid nonwoven technology generally uses latex emulsions, thermoplastic fibers or some combination of both to bond the web's fibers and increase the strength and integrity of the sheet. The process yields a paper-like fabric that is thicker, softer and more absorbent than paper. It also has greater tear resistance and tensile strength, particularly when wet.

Spun lacing uses high-speed jets of water to strike a web so that the fibers knot about one another. As a result, nonwoven fabrics made by this method exhibit softness and drapability.

DRC is a non-woven fabric made from strong wood fibers combined with a binder (e.g., a synthetic latex) and then double creped to give the fabric inelastic stretch as well as softness and wipe-dry properties. DRC exhibits a very cloth-like feel and a high machine direction stretch. Sellars Absorbent Materials, Inc. of Milwaukee, Wis. and Kimberly-Clark Corporation of Dallas, Tex. manufacture DRC.

In accordance with principles of the invention, two techniques may be used to form a ruffle along an edge. One technique entails integrally forming a ruffle on a web, e.g., along an edge of the web. The other technique entails forming a ruffled edge by attaching a strip to an edge of a web of material.

The integral technique is a single-component technique. A web of paper or nonwoven material is processed in such a way that one or more of its edges become ruffled. The part that is ruffled is an integral part of the web, not attached as a separate piece. Ruffles may be integrally formed on more than one edge, and at areas other than an edge.

In the alternative multi-component technique, a relatively narrow strip of paper or other nonwoven material is processed to create a ruffle. The processed strip is then attached to the web, usually very close to an edge of the web. Ruffled strips may be attached to more than one edge of the product, and attached to areas other than near an edge. For example, several double-wide ruffled strips may be attached to points across the web. Then the web may be slit through (e.g., down the middle of) each double wide strip.

In one forming method, part of a web or strip is stretched while another part of the web or strip is not stretched. Where the stretched portion comprises an edge, a ruffle will form. Nonwoven fabric, such as air laid, spun laid and DRC, will permanently stretch, within certain limits, without rupturing. The stretching may be accomplished by embossing an edge of the web or strip, or by other mechanical means.

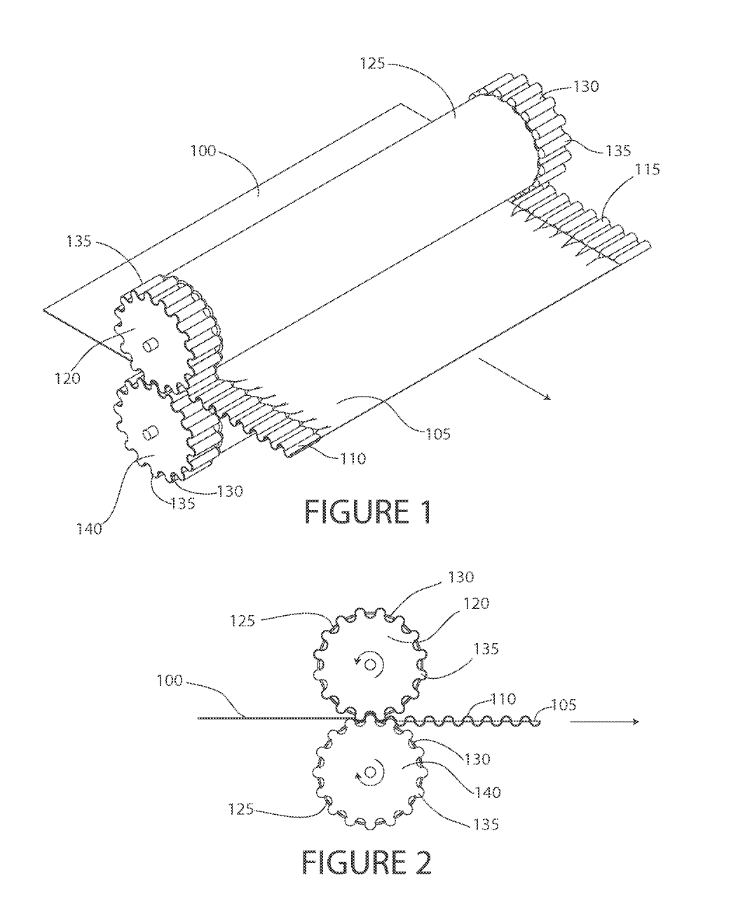

With reference to FIGS. 1 and 2, top perspective and front views of exemplary edge embossing rollers according to principles of the invention are conceptually illustrated. Embossing gives the paper a three-dimensional undulating edge pattern. Union embossing rollers 120, 140 comprise two rigid rolls. One roller 140 rotates clockwise while the other roller 120 rotates counterclockwise to continuously draw the web 100 through the space therebetween. One or both rollers may or may not be heated to facilitate stretching and/or make the stretch more permanent. The rollers 120, 140 have embossing areas comprising smooth wavelike undulations featuring successive peaks 135 and valleys 130 that mesh. Having a somewhat conical shape with a tapered amplitude in the successive peaks 135 and valleys 130 that mesh may be advantageous. In such an implementation the elevations of the peaks 135 and valleys 130 would gradually approach each other near the unruffled areas of the web, and be at their maximum difference in elevation at the point that will coincide with the eventual free edges of the ruffles. The configuration of the embossing areas stretches the contacted areas 110, 115 of the drawn web 105 without causing structural failure. The remaining portion(s) 125 of the rollers 120, 140 do not cause similar stretching. In a practical application, the part of FIG. 1 that is numbered 125 could be a narrow shaft. Such portions may be smooth or textured to impart certain properties to the unstretched section(s) 105 of the web 100. The distance between the rollers 120, 140 is adjusted in such a way that it is identical or nearly identical to the thickness of the web 100 to be embossed or greater than the thickness of the web 100. The result of union embossing is stretching at the edge of the web 100. Each stretched area 110, 115 exhibits a smooth undulating pattern that converges on the adjacent, unstretched, generally planar portion 105. The smooth undulating pattern 110, 115 forms an integral ruffle in the web 100.

While two ruffles are shown on opposite edges of the web 100, fewer or more ruffles may be formed. By way of example, a ruffle may be formed along only one edge. Alternatively, one or more intermediate ruffles may be formed between the edges. In subsequent processing, a blade may slice the web between each intermediate ruffle. Each portion of the sliced ruffle will then form an edge of a roll or sheet having a narrower width than the original roll.

Embossing by means other than union calenders or rollers may be applied to form the desired undulating pattern of stretching. For example, matrix embossing may be applied. Equipment for matrix embossing comprises a heated roll and a soft covered roll whose diameter is typically different than that of the top roll (e.g., double). The top roll includes one or more embossing areas. By pressing both rolls together and running them at low speed, the pattern of the top roll is imprinted on the bottom roll. As a result, a paper web passed through the nip will have an embossed laid pattern on the embossed sections of the web.

As another method of embossing, the web may be passed between one roller with a hard engraved surface and another roller with a smooth elastic and resilient surface. The smooth resilient surface does not take a permanent set of the pattern.

Another ruffling method entails shortening (i.e., compacting) one part of the web 100 while not similarly compacting the rest. The part that is not or less compacted (i.e., loosely compacted) will form ruffles. The compaction must be permanent; otherwise the ruffles will disappear. Compaction can be accomplished by several different methods.

For convenience of reference, the compacted areas are referred to herein as tightly compacted. Tightly compacted areas exhibit durable compaction with relatively low amplitude high frequency undulations. A preferred compaction range for a tightly compacted area is from about 10%-45% and a more preferred compaction range is from about 15%-30%. The percentage of compaction is determined by subtracting from 1 the quotient of the compacted length of a section in the machine direction divided by the original uncompacted length of that section in the machine direction and expressing the result as percentage. Thus, for example, a 20% compaction means that a section is 80% of its original uncompacted length. Adjacent areas that have not been subjected to the tight compaction become loosely compacted, which is a compaction with greater amplitude (if uncreased) and lower frequency undulations. These adjacent areas are not entirely uncompacted, because the tight compaction area forces at least some compaction (i.e., gathering), with diminishing transitional compaction.

One preferred compacting method is creping or microcreping, which compacts the strip or web in one direction. If one edge of a strip is compacted by creping, the opposite edge will form ruffles. If a portion of a web is creped, the adjacent portion(s) that are not creped will form ruffles.

Of the several creping processes available, a uniquely modified version the Micrex® process is preferred. The conventional Micrex® process is described in U.S. Pat. Nos. 4,717,329 and 4,921,643; which are incorporated herein by this reference. Micrex® is a registered trademark of the Micrex Corporation of Walpole, Mass.

The Micrex® process generally entails passing a web over a roller and a blade between a retarding surface thereby forming corrugations. The Micrex® process is modified as it is applied to the subject invention. The modification entails uniquely configuring the retarding surface to tightly compact (i.e., microcrepe) only one or more selected portions of the web, not the entire web. By way of example and not limitation, the retarding surface may be made equal to the width of the central tight compaction zone. The outer edges of the web may be allowed to move freely. As the web travels through the equipment, the zone of the web which travels through the tight compaction zone buckles and bulks, and reduces in length, while the outer regions (i.e., bands) freely travel along without any compaction, albeit at the retarded speed of the buckled web. The free outer edge of the band is less compacted, while its inner edge in contact with the buckled zone is equal to the compacted length. Consequently, loosely bands form a ruffle. With a wider retarding surface completely covering the substrate on one side, a one sided ruffled web may be created. A ruffled web can then be sheeted and folded, in line with the compacting equipment or in a standalone machine to produce stacks of disposable napkins or towels with one or both edges ruffled. Thus, the tightly compacted portions will comprise unruffled areas. Ruffles are formed on the loosely compacted portions (i.e., the bands that have not been directly compacted) that are adjacent to the microcreped areas. These loosely compacted portions comprise a transition zone that abuts the tightly compacted portions. In the transition zone, the web gradually changes from tightly compacted to loosely compacted, with the frequency of undulations increasing with proximity to the tightly compacted portion and diminishing with distance away from the tightly compacted portion, and the amplitude of the undulations decreasing with proximity to the tightly compacted portion.

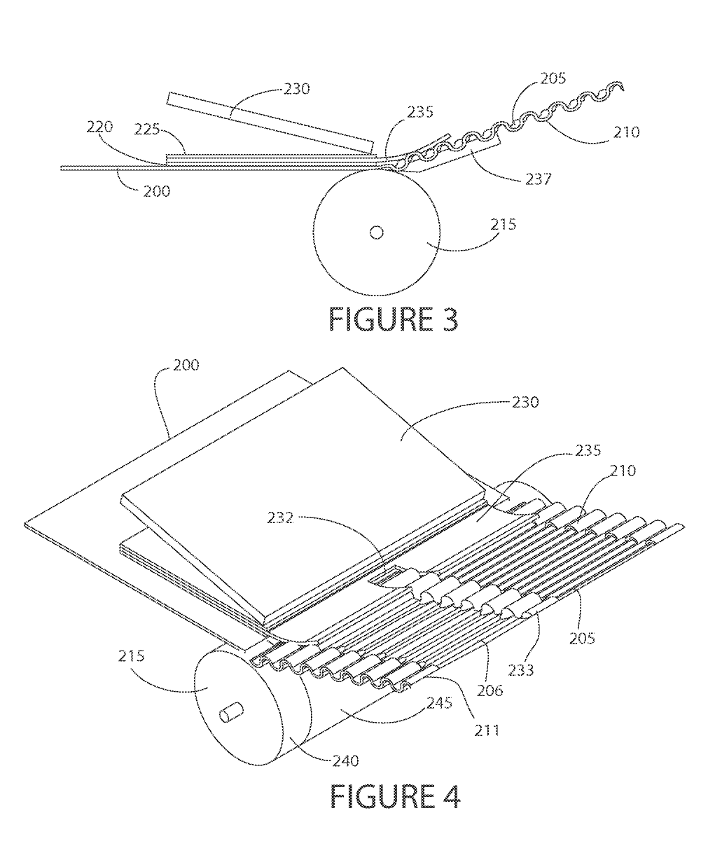

With reference to FIGS. 3 and 4, in the microcreping process, a web 200 is conveyed between a rotating drive roll 215 and a blade 237 converging toward the roll 215. A pressure plate 230 urges a retarder 235 against the web 200, where mechanical bulking takes place. Uniquely, in the present invention, the retarder 235 is configured to extend across only selected parts of the web, to with, each part of the web 205 to be compacted, which is less than the entire web width. In particular, one or more cutouts 232 are formed on the retarder. Each such cutout defines an area that will be loosely compacted. Thus, the part subjected to the retarder corresponds to a portion 245 of the drive roll 215. The retarder 235 contacts only the portion 205 of the web 200 to be tightly compacted. Portions of the web that do not contact the retarder 235, such as portions 210, 211 and 233, will be loosely compacted, exhibiting diminishing transitional compaction. These loosely compacted areas correspond to the edge areas 240 of the drive roll 215, as well as one or more areas between the edges. The web 200 is carried by a rotating drive roll 215. The blade 237 is configured with a width that is sufficient to allow the entire web to pass across the blade 237.

A pressure plate 230 urges the cantilevered retarder 235 towards the web 200. The cantilevered retarder 235 is sandwiched between a pair of support plates 220, 225. The rotating drive roll 215 has either a grooved surface or a flat (non-grooved) surface. While the web 200 is under applied pressure, the web 200 impinges upon the retarding surface of the retarder 235. The web is urged through the space between the retarding surface and a creping blade 237 positioned in the path of the sheet. The creping blade 237 is flat when the drive roll surface is flat. The creping blade is combed when the drive roll surface is grooved.

The retarding surface in combination with the applied pressure induces the sheet into a creped form, with a resulting distortion of the planar aspect of the original sheet. As a result of the process, the tightly compacted portion 205 of the web 200 is imparted with a generally V- or u-shaped undulating corrugation, fluting or creped profile. The final sheet 200 exhibits an area of pronounced compaction or shortening 205 in the machine direction, and one or more adjacent loosely compacted areas 210. Each tightly compacted area has been subjected to a retarder 235 and blade 237. The adjacent loosely compacted areas 210 exhibit ruffling as a result of the transition from the compacted area to the loosely compacted area.

The amplitude of the waves (crest to trough) and the length of the waves in the tightly compacted creped portion of the sheet are initially determined by the amount of space between the surface of the drive roll 215 and the retarding surface 235 and the space between the crepe blade 237 and the retarding surface 235. The amplitude and length of the waves in the tightly compacted portion may be adjusted by adjusting the speed of a take-up roll, downstream. The lower the speed of a take-up roll, the greater the amplitude of the waves and the shorter the wavelength.

The compaction ratio depends upon the combination of the amplitude and the frequency of the crepes in the microcreped portion. A preferred degree of mechanical compaction for sheet stability and ruffle prominence is a corrugation pattern with the length of one leg of corrugation approximately twice the web thickness. However, other ratios of leg length to web thickness may be utilized without departing from the scope of the invention. Concomitantly, a preferred compaction range is from about 10%-45% and a more preferred compaction range is from about 15%-30%.

While the Figures illustrate a central loosely compacted area 233 flanked by parallel tightly compacted areas 205, 206 and loosely compacted areas along each edge 210, 211, the invention is not limited to such a configuration. Any plurality of parallel tightly compacted areas separated by one or more parallel loosely compacted areas may be formed.

Ruffles are formed by slicing loosely compacted areas that are between tightly compacted areas. Such areas are referred to herein as ruffle zones. Upon slicing ruffle zone, i.e., a loosely compacted area, along a midline, the resulting divided portions may each have an equal length ruffled edge. However, the slice may be made other than along the midline, resulting in ruffle edges of unequal width. Additionally, the slice may be straight or non-straight (e.g., undulating) to achieve a desired appearance.

While loosely compacted free edges may form ruffles, another source for a ruffle is a sliced ruffle zone, i.e., a loosely compacted area that is between tightly compacted areas. While ruffles formed from loosely compacted free edges have been shown to exhibit less durability and stability than those formed from slicing a loosely compacted area that is between tightly compacted areas, in some applications they are still preferred given their generally greater degree of undulation. Thus, if a manufacturing process results in loosely compacted free edges, they may be sliced and separated from the roll, or they may be retained as ruffled areas. If retained, they may be left as is or trimmed by slitting to provide a clean free edge.

After the ruffle zones are formed on the web, the web may be cut in the machine direction along one or more ruffle zones. Optionally, the slitted free edges may be fluffed to form a full body ruffle. However, slitting may not always exclusively occur in a ruffle zone. In some implementations, a web may also be slit in the tightly compacted areas.

Next, separated sections are wound on smaller rolls. A converter may then process a smaller roll to form finished products, such as hand towels, napkins, toilet tissue and the like. Alternatively, a converter may work with the parent roll before slitting has occurred. The product is then folded to create a finished product. The finished products are then stacked and packaged for shipment and sale. Depending upon the configuration of ruffles and stacks, the finished products may be stacked in alternate orientations, so that increased thickness at a ruffled edge does not result in an unstable tilting stack.

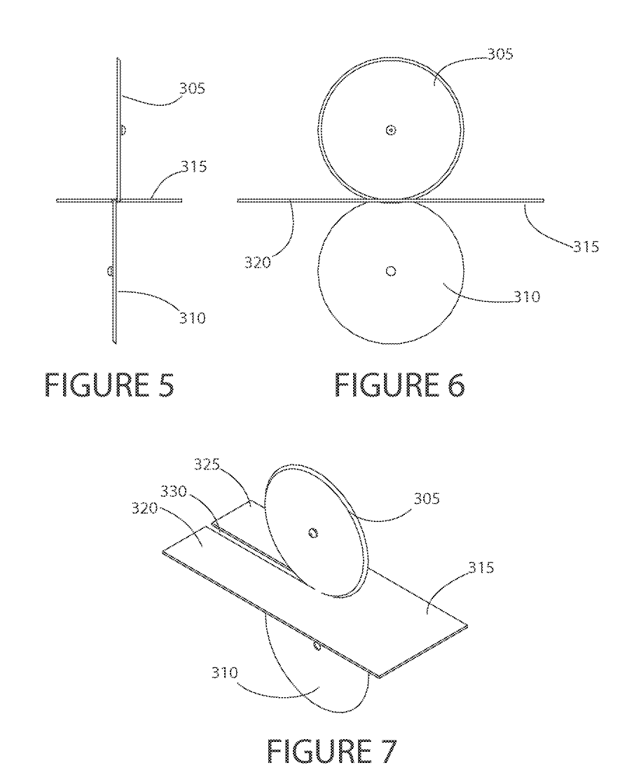

Though various slitting techniques are available, e.g. score slitting, water jet slitting and laser slitting, tangential shear slitting and crush cutting are preferred. In tangential shear slitting, the web 315 is cut between two edge-contacting circular knives, the top slitter blade 305 and the bottom slitter blade 310, as conceptually illustrated in FIGS. 5 through 7. The depth with which the blade should incise into the web depends on the paper grade and ranges between 0.5 and 2.5 mm with 1.5 mm being a normal depth. The overlap of the top blade 305 and the bottom blade 310 should be between 0.5 and 2.5 mm, the exact amount depending again on the grade of the paper to be slit. In crush cutting, the material is severed when it is nipped between a sharp-edged cutter element and an anvil element. As the slitter often generates dust but even under optimum conditions, suction devices may be installed to remove the dust.

It is understood that slitting may occur before or after formation of tightly compacted regions. If it occurs before, the slitting is aligned with the regions to become ruffle zones and/or other regions. As slitting requires tension, it has a tendency to pull out some of the tight compaction. In some cases, the pulling out may be insubstantial. However, if the pulling out is substantial, it may be best to perform the operation before compaction.

The pair of knives must be accurately positioned so as to obtain precisely the desired ruffling for the sheets. In one embodiment, the apparatus for positioning has slides displaceable along guides. Positioning can be carried out manually, semi-automatically or in a fully automated manner.

After slitting, a slit 330 is formed in the web 315, separating the web 315 into discrete sections 320, 325. Each of the sections may then be rewound onto separate rolls. Thus, a large parent roll is converted into smaller rolls, each of which includes a ruffled portion and is suitably sized for subsequent processing by the manufacturer or a customer, such as a converter. Such subsequent processing may include sheet cutting, piling and packaging. A sheet cutter cuts the web into individual sheets, i.e. cuts the web first in machine direction and then in cross direction. Individual sheets may then be piled automatically and packed.

While the Micrex® process has been described as a preferred method for mechanically compacting a portion of a web, it will be appreciated that any alternative methods that now exist and are known or later developed for compaction may be likewise suitable for practice of the invention. Such other compaction techniques are intended to come within the scope of the invention.

By way of example and not limitation, another compacting technique is creping. Crepe paper a crinkled texture; usually colored and used for decorations, is produced on a paper machine that has a single large steam heated drying cylinder (yankee) fitted with a hot air hood. The yankee cylinder is sprayed with adhesives to make the paper stick. Creping is done by the yankee's doctor blade that is scraping the dry paper of the cylinder surface. The crinkle (creping) is controlled by the strength of the adhesive, geometry of the doctor blade, speed difference between the yankee and final section of the paper machine and paper pulp characteristics. The crinkled area is tightly compacted. The crepe ratio reflects how much the paper has shortened during creping, which is normally between 10-30%. Creping adjusts the paper's stretch and thickness, both of which have a marked effect on softness and absorbency. By selectively creping tightly compacted portions of the web, and forming at least one loosely compacted portion, a ruffle may be formed. Again, preferably the ruffle is formed by slicing a loosely compacted area that is between tightly compacted areas. However, a ruffle may also be formed along one or both free edges.

Another integral ruffling method entails shortening (i.e., compacting) the entire web 100 and then stretching certain portions to form ruffles. The stretching will undo the compaction. Except for the stretched areas, the compaction must be permanent; otherwise the ruffles will disappear. The compaction can be accomplished by several different methods, including, but not limited to, the Micrex® microcreping process, as described above. Stretching may be achieved by embossing, as described above. Stretching may also be achieved by applying a draw force, well below the strength of the web, to the areas that require stretching. Downstream rollers that engage the sections to be stretched may exert tensile forces at the point of engagement. Force application results in localized web stretch in the machine direction.

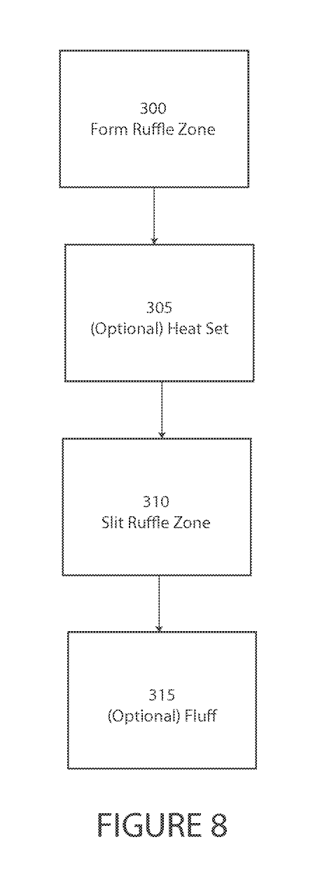

Referring now to FIG. 8, a high level flow chart conceptually illustrates steps of an exemplary ruffling methodology according to principles of the invention. The first step 300 of the exemplary methodology entails forming a ruffle zone. A process of forming a ruffle zone is described above.

After the ruffle zone has been formed, the web may be heat set, as in step 305. Alternatively, heat setting may be performed while the ruffle zone is being formed. Heat setting 305 is optional and may occur at any of various stages of the process, including before or after slitting. Heat setting entails thermally processing the material in either a steam atmosphere or a dry heat environment. The effect of the heat setting is enhanced fabric dimensional stability and, often, higher volume and wrinkle resistance, and enhanced ruffle durability and stability. Heat setting may be accomplished off-line by placing the material in an autoclave. Alternatively, in-line steaming and drying steps may be performed to accomplish heat setting. Heat setting may also be accomplished by exposure to heated rolls, heated air streams and the like.

The process also entails slitting a ruffle zone as in step 310. While various slitting techniques are available, e.g. water jet slitting and laser slitting, tangential shear slitting as described above is preferred.

Another step of the process is fluffing, as in step 315. Fluffing 315 entails mechanically and/or pneumatically urging the ruffled sections to enhance the amplitude of the formed ruffles. Fluffing produces a more full-bodied ruffle. One or more air streams and/or compressed air jets may impinge upon the ruffled area. In one exemplary embodiment, spaced apart oppositely directed pulsed jets of compressed air may be directed at a ruffled area to enhance the magnitude of the undulations. Alternatively, a web may be advanced on brushes and/or soft rolls to enhance the magnitude of the undulations. As another alternative, the material may be vibrated, such as by traveling over a vibrating roller, to accentuate the undulations. As yet another alternative, the free edge may be mechanically stretched by running a free edge over a longer path than the remaining portions. Stretching may be used alone or in combination with one or more of the aforementioned fluffing techniques to provide a full-bodied ruffle.

An exemplary product of a process as described above is a unitary ruffled sheet. The unitary ruffled sheet is a thin sheet of material with a plurality of edges. At least one edge is an integrally formed ruffled edge. In a particular preferred embodiment each lateral edge is an integrally formed ruffled edge. Each ruffled edge comprises loosely compacted sheet material that is not microcreped. At least a portion of the thin sheet that abuts each ruffled edge (but excludes the ruffled edge) comprises tightly compacted sheet material. The tightly compacted sheet material is microcreped sheet material compacted in a direction parallel to the ruffled edge. The tightly compacted sheet material is compacted from about 10% to 40%, preferably about 15%-30%.

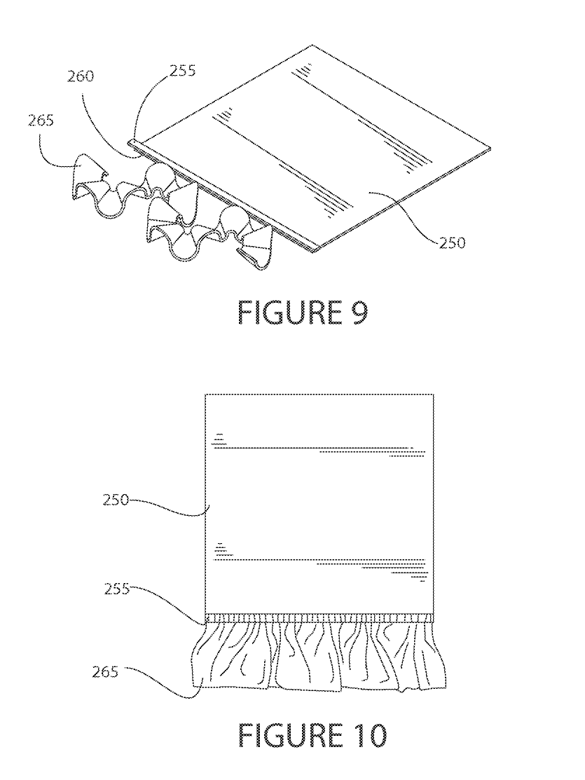

With reference to FIGS. 9 and 10, in an exemplary multi-component process, a relatively narrow strip of paper or nonwoven material 265 is processed to create a ruffle. The processing may entail embossing the strip 265 to form a ruffle, using embossing techniques as described above. The processed strip 265 may then be attached to the web 250, typically very close to an edge 260 of the web 250. The strip may be attached using an adhesive (e.g., glue), a mechanical fastener (e.g., stitching), or compression weld (aka, ply bonding or edge embossing).

Another exemplary method of forming a ruffle for attaching to web in a multi-component process entails attaching a stretched elastic material 255 to a strip 265, and then allowing the elastic to contract. The elastic material 255 comprises an elongated elastic band, such as elastic netting, one or more bands, one or more filaments, or one or more strips of netting. The strip 265 comprises a paper (e.g., tissue paper) strip. The elastic band is stretched to between 2 and 3 times its original length and held in that position. Small amounts of an adhesive are then applied to one side of the elastic band. Alternatively, the adhesive property may be made into the elastic material. For instance, machine direction filaments of netting could be elastic, while cross direction filaments could have an adhesive surface. The strip of paper 265 is then pressed against the side of the stretched elastic band to which the adhesive had been applied. After the glue sets, the elastic band is allowed to contract. If the elastic band was applied to only one edge of the strip 265, then the opposite side of the strip exhibits ruffles when the elastic band has contracted. If elastic bands, filaments or netting were stretched in both directions and attached to the middle (but not the edges) of a relatively wide strip, then ruffles form along the two opposite edges running parallel to the elastic strip when the elastic is allowed to contract.

Another exemplary method of forming a ruffle on a web in a multi-component process entails attaching a curved strip to the web. The curved strip has an outer edge longer than the opposite inner edge. The shorter edge of the curved strip is attached to the web. The edge of the strip may be attached at an edge of the web, near an edge of the web, or at another location. The edge of strip is attached in such a way that the edge is forced to be straight. The free outside edge will then ruffle. The edge of the strip may be attached with any appropriate attachment method, including, but not limited to, gluing (e.g., applying an adhesive or hot melt), stitching, or mechanical bonding such as ply bonding methods typically used on paper.

A hand towel, having a ruffle applied to one edge (i.e., a machine direction edge), is easier to produce than a napkin with a ruffle around multiple edges. Nevertheless, skilled artisans will appreciate that the invention enables forming ruffles on more than one edge, including perpendicular edges. For example, a stream of folded towels or napkins may be fed into an embossing station to add a ruffle to an edge that is perpendicular to a previously ruffled edge. Other stretching and compaction operations may be applied to the paper product to facilitate forming additional ruffles. Additionally, ruffles may be attached to one or more edges using any of the multi-component processes described above.

The “ruffle factor” quantifies fullness of the ruffles. It is calculated as a ratio of lengths. For a strip that is ruffled on one edge, the ruffle factor would be the unruffled length of the long edge divided by the linear length of the ruffled edge. Greater values for the ruffle factor result in more full-bodied ruffles. Ruffle factors between 2 and 3 have been found satisfactory, and are achievable using the methods described above.

The invention offers many advantages beyond forming ruffles. The principal method of selectively compacting regions of a web to form ruffles is a pure mechanical process and does not require any adhesive fluid or drying, and bulks the sheet with little loss in strength. Although the primary purpose of the process is to create ruffles, other useful properties such as bulk, stretch, absorption, appearance, softness, drape ability, etc., are all improved, and all that with no or minimal compromising of strength. Again, sometime strength itself is improved.

Moreover, the invention facilitates dispensing. Individual items in stacks often have a tendency to block, i.e., they stick to each other to hinder dispensing one at a time. Often the item below has to be touched to cause separation. The situation is worse in the case of towels which have to picked up with wet fingers. Ruffles according to the invention are free formed and do not mesh or nest. Consequently, ruffled products formed in accordance with the invention can be easily picked up by the ruffled edge without touching the one below, thus ensuring sanitary dispensing.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of forming a ruffle along an edge of a substrate material, said method comprising steps of
forming a ruffle zone between lateral edges of a web of substrate material traveling in a machine direction, said ruffle zone comprising a loosely compacted region between adjacent parallel tightly compacted regions on the web; and
slitting the ruffle zone in the machine direction between the parallel tightly compacted regions on the web, said slitting dividing the ruffle zone and forming opposed edges, wherein at least one of the opposed edges is ruffled.

2. A method of forming a ruffle along an edge of a substrate material according to claim 1, further comprising forming the parallel tightly compacted regions on the web by selectively creping areas of the web to constitute the parallel tightly compacted regions, the area between the parallel tightly compacted regions comprising the loosely compacted region, not being creped, but exhibiting diminishing transitional compaction from tight compaction of the adjacent parallel tightly compacted regions.

3. A method of forming a ruffle along an edge of a substrate material according to claim 1, further comprising forming the parallel tightly compacted regions on the web by selectively microcreping areas of the web to constitute the parallel tightly compacted regions, the area between the parallel tightly compacted regions comprising the loosely compacted region, not being microcreped, but exhibiting diminishing transitional compaction from tight compaction of the adjacent parallel tightly compacted regions.

4. A method of forming a ruffle along an edge of a substrate material according to claim 1, further comprising forming the parallel tightly compacted regions on the web by selectively microcreping areas of the web using the Micrex® process to constitute the parallel tightly compacted regions, the area between the parallel tightly compacted regions comprising the loosely compacted region, not being microcreped, but exhibiting diminishing transitional compaction from tight compaction of the adjacent parallel tightly compacted regions.

5. A method of forming a ruffle along an edge of a substrate material according to claim 1, further comprising forming the parallel tightly compacted regions on the web by selectively microcreping areas of the web using the Micrex® process to constitute the parallel tightly compacted regions, the area between the parallel tightly compacted regions comprising the loosely compacted region, not being microcreped, but exhibiting diminishing transitional compaction from tight compaction of the adjacent parallel tightly compacted regions, said Micrex® process being performed using a retarder with a cutout corresponding to the loosely compacted region, said cutout avoiding retarder contact with the loosely compacted region during the Micrex® process.

6. A method of forming a ruffle along an edge of a substrate material according to claim 1, wherein said step of slitting the ruffle zone in the machine direction between the parallel tightly compacted regions on the web comprises tangential shear slitting between two edge-contacting circular slitter blades, including a top slitter blade and a bottom slitter blade vertically supported in a path of machine direction travel in alignment with the ruffle zone.

7. A method of forming a ruffle along an edge of a substrate material according to claim 1, wherein said step of slitting the ruffle zone in the machine direction between the parallel tightly compacted regions on the web comprises crush cutting between a sharp-edged cutter element and an anvil element in a path of machine direction travel with the sharp-edged cutter element in alignment with the ruffle zone.

8. A method of forming a ruffle along an edge of a substrate material according to claim 1, wherein said step of slitting the ruffle zone in the machine direction between the parallel tightly compacted regions on the web comprises tangential shear slitting between two edge-contacting circular slitter blades, including a first slitter blade and an opposite second slitter blade supported in a path of machine direction travel in alignment with a midline of the ruffle zone

9. A method of forming a ruffle along an edge of a substrate material according to claim 1, further comprising a step of heat setting the parallel tightly compacted regions.

10. A method of forming a ruffle along an edge of a substrate material according to claim 1, further comprising a step of fluffing the cut ruffle zone, said fluffing entailing mechanically enhancing an amplitude of undulations comprising ruffles.

11. A method of forming a ruffle along an edge of a substrate material according to claim 1, further comprising a step of fluffing the cut ruffle zone, said fluffing entailing pneumatically enhancing an amplitude of undulations comprising ruffles.

12. A method of forming a ruffle along an edge of a substrate material according to claim 1,
wherein said step of forming a ruffle zone between lateral edges of a web of substrate material traveling in a machine direction comprises
forming a plurality of ruffle zones between lateral edges of a web of substrate material traveling in a machine direction, each ruffle zone comprising a loosely compacted region between adjacent parallel tightly compacted regions on the web; and
wherein said step of slitting the ruffle zone in the machine direction between the parallel tightly compacted regions on the web comprises
slitting each ruffle zone in the machine direction between the corresponding adjacent parallel tightly compacted regions on the web, said slitting dividing the ruffle zone and forming opposed edges of separate sheets of the substrate material, wherein each of the opposed edges is ruffled.

13. A method of forming a ruffle along an edge of a substrate material according to claim 12, further comprising forming each parallel tightly compacted region on the web by selectively creping areas of the web to constitute each parallel tightly compacted region, the area between each parallel tightly compacted region comprising the loosely compacted region, not being creped, but exhibiting diminishing transitional compaction from tight compaction of the adjacent parallel tightly compacted regions.

14. A method of forming a ruffle along an edge of a substrate material according to claim 12, further comprising forming each parallel tightly compacted region on the web by selectively microcreping areas of the web to constitute each parallel tightly compacted region, the area between each parallel tightly compacted region comprising the loosely compacted region, not being microcreped, but exhibiting diminishing transitional compaction from tight compaction of the adjacent parallel tightly compacted regions.

15. A method of forming a ruffle along an edge of a substrate material according to claim 12, further comprising forming each parallel tightly compacted region on the web by selectively mechanically forming wave-like undulations on areas of the web corresponding to the parallel tightly compacted regions, the area between the parallel tightly compacted regions comprising the loosely compacted region, not having the mechanically formed wave-like undulations, but exhibiting diminishing transitional compaction from tight compaction of the adjacent parallel tightly compacted regions.

16. A method of forming a ruffle along an edge of a substrate material according to claim 12, further comprising forming each parallel tightly compacted region on the web by selectively microcreping areas of the web using the Micrex® process to constitute each parallel tightly compacted region, the area between each parallel tightly compacted region comprising the loosely compacted region, not being microcreped, but exhibiting diminishing transitional compaction from tight compaction of the adjacent parallel tightly compacted regions.

17. A method of forming a ruffle along an edge of a substrate material according to claim 12, further comprising a step of heat setting each parallel tightly compacted region.

18. A method of forming a ruffle along an edge of a sheet of substrate material, said method comprising steps of
forming a tightly compacted region abutting a free edge ruffle zone comprising a lateral edge of a web of substrate material traveling in a machine direction, said ruffle zone comprising a loosely compacted region adjacent and parallel to the tightly compacted region on the web;
said step of forming the tightly compacted region on the web comprising a compaction process from the group consisting of:
selectively creping an area of the web to constitute the tightly compacted region, and
selectively microcreping an area of the web to constitute the parallel tightly compacted region.

19. A unitary ruffled sheet comprising:
a thin sheet of material having a plurality of edges;
at least one edge comprising an integrally formed ruffled edge, said ruffled edge comprising loosely compacted sheet material that is not microcreped;
at least a portion of said thin sheet that abuts said ruffled edge and excludes said ruffled edge comprising tightly compacted sheet material, said tightly compacted sheet material comprising microcreped sheet material compacted in a direction parallel to said ruffled edge.

20. A unitary ruffled sheet according to claim 19, said tightly compacted sheet material being compacted from about 15%-30%.

21. A method of forming a ruffle along an edge of a substrate material, said method comprising steps of
forming a ruffle zone between lateral edges of a web of substrate material traveling in a machine direction, said ruffle zone comprising a loosely compacted region between adjacent parallel tightly compacted regions on the web;
slitting the web in a tightly compacted region, said slitting dividing the tightly compacted region.
